(19) United States
(12) Patent Application Publication
(10) Pub. No.: US 2022/0068072 A1
(43) Pub. Date: Mar. 3, 2022

(54) Security pattern capable of writing variable coding information and preparation method and device thereof

(71) Applicants: Xianyang Homa Optoelectronic Technology Co., Ltd., Xianyang, Shaanxi (CN); Shanghai Going Anti-counterfeiting Technology Co. Ltd., Shanghai (CN)

(72) Inventor: Lei REN, Zhuhai, Guangdong (CN)

(21) Appl. No.: 17/418,837

(22) PCT Filed: Dec. 20, 2019
(86) PCT No.: PCT/CN2019/127090

§ 371 Date: Jun. 27, 2021

(30) Foreign Application Priority Data
Dec. 29, 2018 (CN) 201811639980.4
Nov. 26, 2019 (CN) 201911172251.7

(51) Int. Cl. G07D 7/004; G07D 7/00

(52) U.S. Cl. CPC G07D 7/004; G07D 7/003

(57) ABSTRACT

Provided are a security pattern capable of writing variable coding information and a preparation method and device thereof. The preparation device includes a coating-printing device, a transmission device, a laser array light source, and an induced magnetic field, the induced magnetic field and the transmission device are synchronous. The laser array light source is used for optical signal output, the light source is programmable-formed, variable, and high in refinement degree, and may output a finer pattern. A point light source array may be controlled by a program and correspondingly prepare a variable code; and a crawler-type magnetic field is used for induction in a pattern transmission process, and the synchronous induction of the conveyor belt type takes a longer time than other inductions, and prepares a more stable pattern.

### TECHNICAL FIELD

The disclosure belongs to the technical field of anti-counterfeiting printing, and relates to the field of security printing, in particular to a security pattern capable of writing variable coding information, and a preparation device and a preparation method thereof.

### BACKGROUND

In October 2015, the People's Bank of China issued a banknote of 100 RMB yuans with a new anti-counterfeiting feature, which was developed by JDSU, Sicpa and KBA companies together. In 2002, the core content of the anti-counterfeiting technology was disclosed in a patent coded 02800567.8, “Magnetic thin film interference device or pigment and manufacturing method thereof, printing ink or coating composition containing such magnetic thin film interference device, secret document and application”, by M. Seto,T. Thiele and E. Miller of Cypress Technology Shareholding Co., Ltd held by Sicpa; the anti-counterfeiting technology is used worldwide at present. It is worth mentioning that a core element of the existing technology is printed pattern and magnetic plate pattern.

The disclosure is to develop an anti-counterfeiting security pattern with both a first-line effect and a second-line machine-readable effect.

### SUMMARY

A purpose of the disclosure is achieved through the following technical schemes.

A security pattern capable of writing variable coding information, which includes a plurality of areas cured in different directions, and part or all of the plurality of the areas contain the variable coding information.

A preparation device for a security pattern capable of writing variable coding information, which includes: a coating-printing mechanism, a substrate conveying mechanism, N groups of point light source arrays, N or N+1 groups of magnetic fields, and an end point curing light source, N=1; the N groups of the point light source arrays and the N or N+1 groups of the magnetic fields are arranged at the same side or two opposite sides of the substrate conveying direction.

The coating-printing device is used for coating and printing a pattern on the surface of a substrate.

The substrate conveying mechanism is used to convey the substrate coated-printed with the pattern; each point light source array is capable of controlling a lighting range and a lighting brightness according to real-time coding information, as to output an optical signal corresponding to the coding information to the pattern coated-printed on the substrate entering an irradiation range of the point light source array, and ink in a corresponding area on the coated-printed pattern being exposed and cured.

Each magnetic field is used to induce the ink in an uncured part of the coating-painted pattern, as to change an angle thereof

The end point curing light source is arranged after the N groups of the point light source arrays and N or N+1 groups of the magnetic fields, and is used to cure all of the uncured part of the pattern, as to achieve complete exposure of the pattern.

The N groups of the point light source arrays and the N or N+1 groups of the magnetic fields are arranged at the two opposite sides of a conveying direction of the substrate, which means that the N groups of the point light source arrays are all arranged above or below the substrate, and correspondingly, the N or N+1 groups of the magnetic fields are all arranged below or above the substrate.

Specifically, along the direction in which the substrate is conveyed, the point light source arrays and the magnetic fields are arranged at intervals one by one, and a group of the magnetic field is arranged between every two adjacent groups of the point light sources, between the last group of the point light source array and the end point curing light source, and before the first group of the point light source array while the number of the magnetic fields is N+1 groups.

Preferably, along the direction in which the substrate is conveyed, a head end of each magnetic field is overlapped or partially overlapped with the nearest point light source array. A purpose of such design is that the ink induced by the magnetic field may maintain the induced direction while it is cured, and confusion or blurring of the direction may not be caused due to demagnetization. Another scheme is that the magnetic field and the point light source array are not overlapped at all. An advantage of such design is that: the magnetic field and the point light source array do not affect mutual effects on the ink in the coated-printed pattern.

Preferably, the magnetic field is a fixed magnetic field or a synchronous magnetic field synchronously conveyed with the substrate.

Preferably, the synchronous magnetic field is formed by fixing an induction magnet or an electromagnetic insert on a flexible conveying mesh belt, and aligned to the coated-printed pattern on the substrate.

Preferably, the synchronous magnetic field adopts a mode of composite superposition of a plurality of the magnetic fields, magnetic force ranges of the magnetic fields are different according to sizes, positions and magnetic moments of the magnetic fields. According to the principle, the effect of a composite magnetic field is obtained by adding a short-distance small magnetic field to an existing long-distance.

Preferably, a minimum distance between the coated-printed pattern and the magnetic field is 0.1 MM-10 CM.

Preferably, the point light source array includes a coding mechanism and an exposing mechanism, the coding mechanism is used to generate the coding information, and the exposing mechanism is used to control the lighting range and the lighting brightness of the point light source array according to the coding information; and the corresponding point light source is a single or multiple point light sources, and it is translated and/or switched on a two-dimensional plane, as to expose and cure a part corresponding to the pattern on the surface of the substrate.

Preferably, the point light source array is a point laser light source array.

Preferably, each laser tube in the point laser light source array is controlled by a circuit to switch and adjust energy intensity; and an equivalent diameter or a rectangular side length of a single point laser light source adopts a range of 10 ηM-10 MM. A laser is emitted from the laser tube, and coupled to an optical fiber through a coupler, and then an emitting angle of the light is collimated at a zero angle through a collimating lens, so the definition of a pattern boundary is improved.

Preferably, the point laser light source array is a two-dimensional array light source or a one-dimensional line array.

Preferably, the point light source array is a controllable point light source array, and condensation, collimation or projection of each controllable point light source thereof may be controlled by a circuit to switch; and an equivalent diameter or a rectangular side length of a single point light source adopts a range of 10 ηM-10 MM.

Preferably, the point light source array further includes a controllable light barrier, it is arranged between the point light source array and the substrate. In the case that the light source of the point light source array is not changed, the exposure control of the point light source array may be achieved by controlling an opening degree of the controllable light barrier.

In an implementation scheme, the number of the point light source arrays is two, they are all arranged above the substrate, and the number of the synchronous magnetic fields is two, they are all arranged below the substrate.

The substrate conveying mechanism is used for conveying the substrate coated-printed with the pattern to an irradiation range of a first point light source array, and the first point light source array is used for outputting an optical signal corresponding to a first area shape and a light-dark pattern that need to be presented on the coated-printed pattern according to a coding signal, as to expose and cure the first area of the coated-printed pattern, and then the substrate is continuously conveyed by the substrate conveying mechanism, the first synchronous magnetic field is driven to be synchronously moved with the substrate by a first synchronous magnetic field conveying device, and the first synchronous magnetic field is used to induce the uncured part, namely the ink outside the first area, of the coating-painted pattern, as to change an angle thereof.

The substrate conveying mechanism is further used for conveying the substrate of which the first area is cured to an irradiation range of a second point light source array, and the second point light source array is used for outputting an optical signal corresponding to a second area shape and a light-dark pattern that need to be presented on the coated-printed according to the coding signal, as to expose and cure the second area of the coated-printed pattern after the action of the first synchronous magnetic field.

The substrate conveying device is further used for conveying the substrate after the action of the second point light source array to an irradiation range of the end point curing light source. In the process, the second synchronous magnetic field is driven to be synchronously moved with the substrate by a second synchronous magnetic field conveying device, the second synchronous magnetic field is used to induce the uncured part, namely ink of an area outside the first area and the second area, of the coated-printed pattern, as to change an angle thereof; and the end point curing light source is used to expose and cure the area after the action of the second synchronous magnetic field.

The disclosure further provides a preparation method for a security pattern capable of writing variable coding information, including the following steps.

S1. Adding an inducible material to coating-printing ink paint, coating and printing on a substrate, to form a photocurable coated-printed pattern; at the same time, providing N groups of point light source arrays, N or N+1 groups of magnetic fields, herein the N groups of the point light source arrays and the N or N+1 groups of the magnetic fields are arranged at the same side or two opposite sides of a conveying direction of the substrate, N=1.

S2. Conveying the substrate, if the number of the magnetic fields is N+1 groups, in a substrate conveying process, firstly inducing the coated-printed pattern by a first group of the magnetic field, and conveying the coated-printed pattern to an irradiation range of a first point light source array, if the number of the magnetic fields is N groups, directly conveying the coated-printed pattern to the irradiation range of the first point light source array, herein the first point light source array forms a pattern light source according to coding information, and the pattern light source is used to expose the coated-printed pattern entering the irradiation range of the point light source array, so that a part, corresponding to the pattern light source, of the coated-printed pattern is cured, as to achieve the effect that a pattern of the pattern light source is transferred to the coated-printed pattern.

S3. Continuously conveying the substrate, and inducing an uncured part of the coated-printed pattern by the magnetic field corresponding to the coated-printed pattern in the process, to reach an irradiation range of the next codeable point light source array, herein the codeable point light source array forms another pattern light source according to the coding information, the another pattern light source is used to expose the coated-printed pattern entering the irradiation range of the point light source array, so that a part, corresponding to the another pattern light source, of the coated-printed pattern is cured.

S4. If necessary, repeating S3 until the substrate sequentially passes through the N groups of the point light source arrays and the N or N+1 groups of the magnetic fields.

S5. Continuously conveying the coated-printed pattern to an irradiation range of an end point curing light source, and totally curing an uncured part of the coated-printed pattern.

Another preparation method for a security pattern capable of writing variable coding information is provided, including the following steps.

S1. Providing a substrate with a coated-printed pattern, herein the coated-printed pattern is a cured state; ink paint used for coating-printing has a liquefaction effect on a light source, namely an exposed part of the coated-printed pattern can be transformed from a high-molecule to a low-molecule, that is it is turned from a solid state to a liquid state; at the same time, providing a pattern liquefied light source, a magnetic field, and an end point curing mechanism, herein the pattern liquefied light source can be coded to control a lighting range and a lighting brightness of the light source, thereby generating a liquefied light source pattern, the magnetic field is arranged after the pattern liquefied light source, and the magnetic field is a magnetic field synchronously moved with the substrate or a fixed magnetic field.

S2. Conveying the coated-printed pattern on the substrate to an irradiation range of the pattern liquefied light source, and transferring the liquefied light source pattern to the coated-printed pattern, so that an area, corresponding to the liquefied light source pattern, in the coated-printed pattern is turned into the liquid state.

S3. Continuously conveying the substrate, and inducing the coated-printed pattern on the substrate by the magnetic field, so that a direction of liquefied ink paint is re-induced.

S4. Continuously conveying the substrate to the action range of the end point curing mechanism, so that the re-induced area is re-cured, as to form a new pattern.

In summary, the disclosure focuses on the following key points.

1. A synchronous induction mechanism is fixed on the flexible conveying mesh belt by using the induction magnet or electromagnetic insert, and aligned to the coated-printed pattern on the substrate; while working, the coated-printed pattern is conveyed at the same synchronous linear speed as the induction magnet below.

2. Preparation under a state of liquefaction light: the induced and solidified pattern is firstly transferred to a liquefaction light area. After irradiation, the pattern of the light source is transferred to the coated-printed pattern to be exposed, an exposed part is liquefied, and then a material of a liquefied part is re-induced at this moment, so that an angle or a shape of the material inside the pattern of the liquefied part is deflected or changed, and then the writing of a digital pattern may be completed by re-curing.

3. Composite magnetic field: the induced magnetic field may adopt the mode of the combination of a plurality of the magnetic fields, the magnetic force ranges of the magnetic fields are different according to the sizes, positions and magnetic moments of the magnetic fields. According to the principle, the effect of the composite magnetic field may be obtained by adding the short-distance small magnetic field to the existing long-distance.

4. The codeable and controllable light source is adopted, through the translating and switching of the point light source in the two-dimensional plane, the coated-printed substrate is exposed and cured to form a corresponding fixed or variable pattern.

5. The ink paint used for coating-printing must have a curing or liquefaction effect on the light source, namely the pattern coated-printed in an exposure range may be changed from the low-molecule to the high-molecule, or from the high-molecule to the low-molecule, through inducing the coating-printing material firstly, it is turned from the liquid state to the solid state, the new pattern is presented, or it is turned from the solid state to the liquid state, and turned to the solid state after being induced, thus the new pattern is presented.

Compared with the prior art, the disclosure has the following advantages.

1. The disclosure uses the laser array light source for optical signal output. The light source may be coded to form a light pattern. It has the advantages of variable and high degree of refinement. It may output the finer pattern. The light source of the point array may be controlled by the program, and a variable code is correspondingly prepared.

2. The crawler-type magnetic field is used to induce in the pattern conveying process. Conveyor-type synchronous induction has a longer induction time than other methods, and may prepare the more stable pattern.

### BRIEF DESCRIPTION OF THE DRAWINGS

FIGS. 1 to 4 are schematic diagrams of a security pattern in each step of Embodiment I of the disclosure;

FIG. 5 is a schematic diagram of a security pattern according to Embodiment II of the disclosure;

FIG. 6 is a schematic diagram of a security pattern according to Embodiment III of the disclosure;

FIGS. 7-9 are schematic diagrams of a pattern in each step of Embodiment IV of the disclosure;

FIG. 10 is a schematic diagram of a principle of a preparation device of Embodiment I of the disclosure; and

FIG. 11 is a schematic diagram of a principle of a preparation device of Embodiment V of the disclosure.

### DETAILED DESCRIPTION OF THE EMBODIMENTS

### Embodiment I

The embodiment provides a security pattern capable of writing variable coding information, a preparation device and a preparation method thereof.

The security pattern capable of writing the variable coding information is a coated-printed ink layer pattern. The coated-printed ink layer pattern includes: a first area, a second area, and a third area formed by stepwise exposing and curing, herein the first area is an overlapping part of the second area and the third area, and curing directions of coating-printing ink in the three areas are all different.

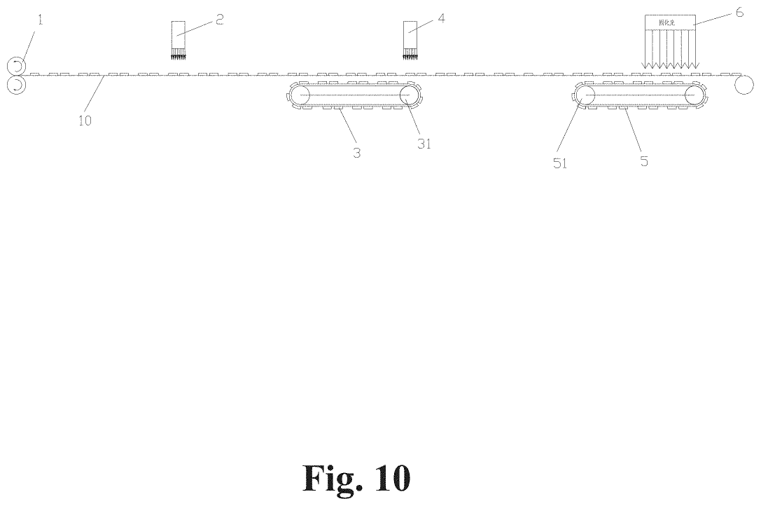

As shown in FIG. 10, the preparation device includes a coating-printing device, a substrate conveying device 1, a first group of point laser light source arrays 2, a first magnetic field 3, a first magnetic field conveying device 31, a second group of point laser light source arrays 4, a second magnetic field 5, a second magnetic field conveying device 51 and a curing light source 6.

The coating-printing device is used for coating and printing a pattern on the surface of the substrate 10; the substrate conveying device 1 is used for conveying the substrate 10 coated-printed with the pattern to an irradiation range of the first group of the point laser light source arrays 2; the first group of the point laser light source arrays 2 is used for outputting an optical signal corresponding to a shape of the first area according to a coding signal, and exposing and curing the first area, and the substrate conveying device 1 is further used for conveying the substrate 10 of which the first area is cured to an irradiation range of the second group of the point laser light source arrays 4. In the process, the first magnetic field 3 is arranged below the coated-printed pattern, and driven to be synchronously moved with the substrate 10 by the first magnetic field conveying device 31, and the first magnetic field 3 is used to induce the ink in an uncured part of the coating-painted pattern, as to change an angle thereof; the second group of the point laser light source arrays 4 is used for outputting an optical signal corresponding to a shape of the second area according to the coding signal, and exposing and curing the second area after being acted by the first magnetic field 3, the substrate conveying device 1 is further used for conveying the substrate 10 after being acted by the second group of the point laser light source arrays 4 to an irradiation range of the curing light source 6. In the process, the second magnetic field 5 is arranged below the coated-printed pattern and driven to be synchronously moved with the substrate 10 by the second magnetic field conveying device 51, the second magnetic field 5 is used to induce the ink in the uncured part of the pattern, as to change the angle thereof; and the curing light source 6 is used for outputting an optical signal corresponding to a shape of the third area according to the coding signal, and exposing and curing the third area after being acted by the second magnetic field.

The first magnetic field 3 and the second magnetic field 5 are both synchronous magnetic fields, the synchronous magnetic field is formed by fixing an induction magnet or an electromagnetic insert on a flexible conveying mesh belt, and aligned to the coated-printed pattern on the substrate 10.

The point laser light source arrays 2 and 4 include a coding mechanism and an exposing mechanism. The coding mechanism is used to generate coding information, and the exposing mechanism is used to control a lighting range and a lighting brightness of the point laser light source array according to the coding information; and the point light source in the point laser light source array is a single or multiple point light sources, through controlling translating of the point light source on the two-dimensional plane, or switching of the point light source on the two-dimensional plane, or translating and switching of the point light source on the two-dimensional plane, a part, corresponding to the pattern on the surface of the substrate, is exposed and cured.

Each laser tube in the point laser light source array is controlled by a circuit to switch and adjust energy intensity; an equivalent diameter or a rectangular side length of a single point laser light source is in a range of 10 ηM-10 MM. The point laser light source array is a two-dimensional array light source or a one-dimensional line array.

The point laser light source array may be replaced with a controllable point light source array. Condensation, collimation or projection of each controllable point light source in the controllable point light source array may be controlled by a circuit to switch; and an equivalent diameter or a rectangular side length of a single point light source is in a range of 10 ηM-10 MM.

The preparation method includes the following steps.

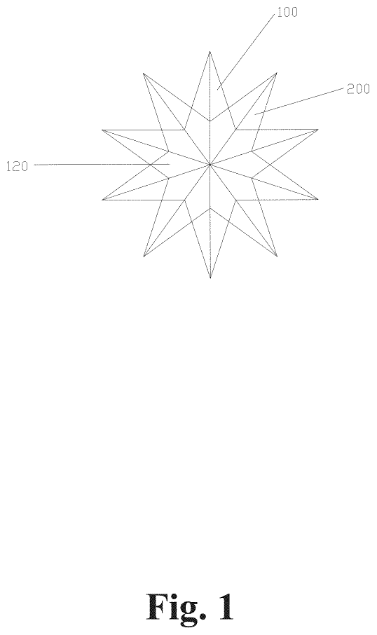

S1. The coating-printing device is used for coating and printing the pattern shown in FIG. 1 on the surface of the substrate, the coating-printing ink used contains a material that may be induced by the magnetic field, and the material has a photocurable property. The pattern is formed by intersecting and overlapping two five-pointed star patterns 100 and 200, a center 120 thereof is overlapped, and peripheral corners are not overlapped, but are circumferentially scatted along the center 120.

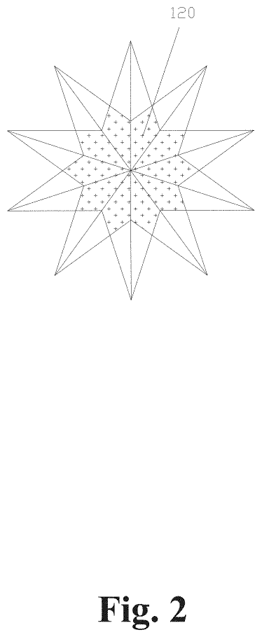

S2. The substrate 10 coated-printed with the pattern is conveyed to the irradiation range of the first group of the point laser light source arrays 2 through the substrate conveying device 1, and the first group of the point laser light source arrays 2 outputs the optical signal of the shape corresponding to the center 120 of the above pattern according to the coding signal, and irradiates the center 120 of the pattern, the part is cured after being exposed, and magnetic pigment powder in the range of the center 120 is cured so that the angle is fixed. At this time, the parts outside the center 120 parts of two five-pointed stars 100 and 200, namely a total of 10 corners of the first pentagonal part and the second pentagonal part, are not cured, as shown in FIG. 2.

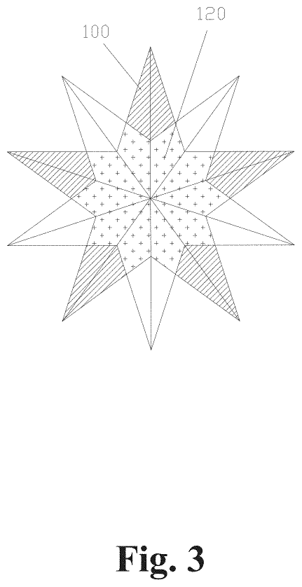

S3. The substrate 10 coated-printed with the pattern after the treatment in the S2 is continuously conveyed through the substrate conveying device 1, and at the same time, one first magnetic field 3 which is synchronously moved with the pattern is arranged below the pattern, a coating-printing material of an uncured pattern part in the S2 is re-induced, so that the angle thereof is changed, the conveying is stopped after reaching the irradiation range of the second group of the point laser light source arrays 4, the second group of the point laser light source arrays 4 outputs an optical signal corresponding to the shape of the first pentagonal part, except for the center 120, of the first five-pointed star 100 in FIG. 1 according to the coding signal, and the first pentagonal part is exposed and cured, the magnetic pigment powder in the range of the first pentagonal part is cured so that the angle is fixed. At this time, the second pentagonal part is not cured, as shown in FIG. 3. It should be noted that in order not to affect the presentation of the cured part, the angle change generated while the second pentagonal part is induced by the first magnetic field 3 is not shown in FIG. 3.

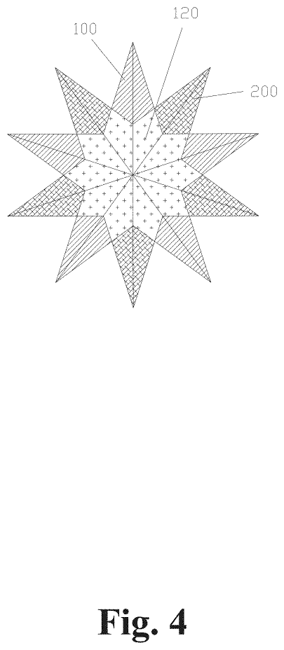

S4. The substrate coated-printed with the pattern after the treatment in the S3 is conveyed by the conveying mechanism, and at the same time, one second magnetic field which is synchronously moved with the pattern is arranged below the pattern, the coating-printing material of the uncured second pentagonal part in the S3 is re-induced, so that the angle thereof is changed, and then the conveying is stopped. The third group of the point laser light source arrays outputs an optical signal corresponding to the shape of the second pentagonal star according to the coding signal, the second pentagonal part is exposed and cured, and the magnetic pigment powder in the range of the second pentagonal part is cured so that the angle is fixed. At this time, the coating-printing materials in the center 120, the first pentagonal part and the second pentagonal part are respectively cured to unique angles, so that the entire pattern shown in FIG. 1 is completely exposed, and the entire pattern is cured to form the security pattern, as shown in FIG. 4. The security pattern continuously presents three different bright surfaces while a viewing angle is changed: the first pentagonal part, the second pentagonal part and the center 120.

In the embodiment, the center 120 corresponds to the first area, the first pentagonal part corresponds to the second area, and the second pentagonal part corresponds to the third area.

### Embodiment II

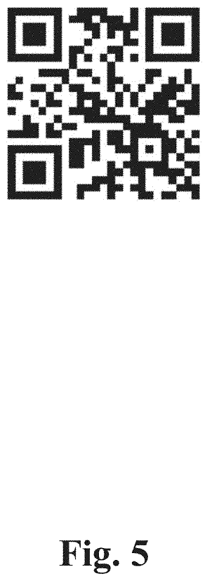

The embodiment provides another security pattern capable of writing variable coding information, and a preparation device and a preparation method thereof, it is similar to Embodiment I, a difference is only that: the patterns are different. Specifically, the pattern of the embodiment is a two-dimensional code, as shown in FIG. 5.

The preparation method is as follows: a rectangular square is coated-printed on the surface of a substrate by a coating-printing device, a point laser light source array outputs a pattern in the shape of a black part to the rectangular square according to a coding signal, the part is cured after being exposed, and magnetic pigment powder in the pattern is cured so that an angle is fixed; at this time, the substrate with the pattern is continuously conveyed by a conveying mechanism, and at the same time, a magnetic field synchronized with the substrate is arranged below the pattern, a material inside the part of the uncured pattern is re-induced, so that an angle thereof is changed, the pattern is exposed as a whole by a complete exposing mechanism, and the pattern is cured as a whole. After such a process, a machine-readable two-dimensional code is formed.

The above array type point light source may be controlled by coding to form various variable patterns, and the variable patterns are transferred to the pattern surface through exposure, as to form a series of security patterns of variable coding information with one-object one-image codes.

An advantage of the security pattern is that it may form very apparent changes in brightness, color, graphics and the like, may write a two-dimensional code that may be read by a smart phone, and may write any pattern that may be read with a specific encryption.

### Embodiment III

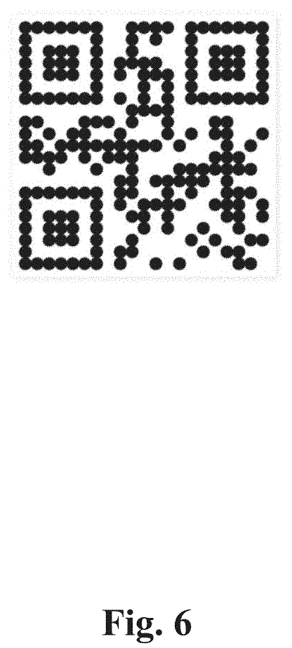

The embodiment provides another security pattern capable of writing variable coding information, a preparation device and a preparation method thereof, it is similar to Embodiment I, and a difference is only that: the patterns are different, as shown in FIG. 6 specifically. The pattern of the embodiment is a circular point-like two-dimensional code.

The preparation method is as follows: a 20*20 circular point array is coated-printed on a substrate (QRcode positioning is further included in the pattern) by a coating-printing device, the size of each circular point is 0.9 MM in diameter, and a point laser light source array in which each laser point is 1 MM in diameter outputs a pattern of a coded two-dimensional light-dark point array according to a coding signal, the bright part is cured after being exposed, and magnetic pigment powder in the pattern is cured so that an angle is fixed; and the coated-printed pattern enters a second magnetic field, an uncured part is induced to another angle, after that, it is cured as a whole, so the circular point-like two-dimensional code is completely prepared.

### Embodiment IV

The embodiment provides another security pattern capable of writing variable coding information, a preparation device and a preparation method thereof, it is similar to

Embodiment I, and a difference is only that: the patterns are different, and the induced magnetic fields used are different. Specifically, a composite magnetic field used in the embodiment is composed of multiple magnetic poles and a fixture that fixes the magnetic poles.

### Preparation Process

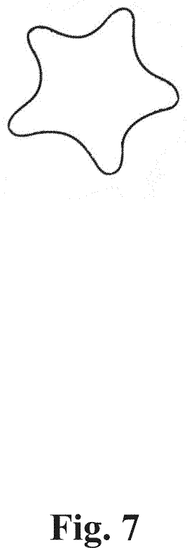

1. Firstly, an outline of a starfish shape is coated-printed on a substrate, as shown in FIG. 7.

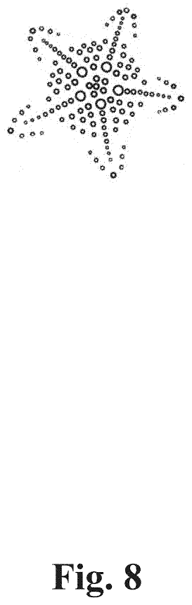

2. The composite magnetic field is used to induce the coated-printed substrate, as shown in FIG. 8.

An upper part of the composite magnetic field, namely a position closed to the coated-printed pattern, is a magnetic field in which a plurality of small magnetic rings are distributed, and a lower part of the composite magnetic field is a bar-shaped columnar magnetic field, the small magnetic rings and the bar-shaped columnar magnetic field are clamped by the fixture made of a non-magnetic material, and arranged below the coated-printed starfish outline.

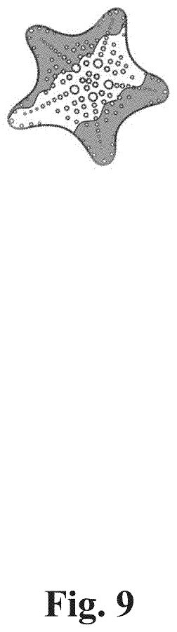

3. After induction, photocuring is performed to obtain a three-dimensional starfish pattern with densely distributed ring light spots in the pattern and a changing light column as a whole: a white part is a columnar bright fringe part, according to an observation angle change, a rolling bright fringe is translated, as shown in FIG. 9.

### Embodiment V

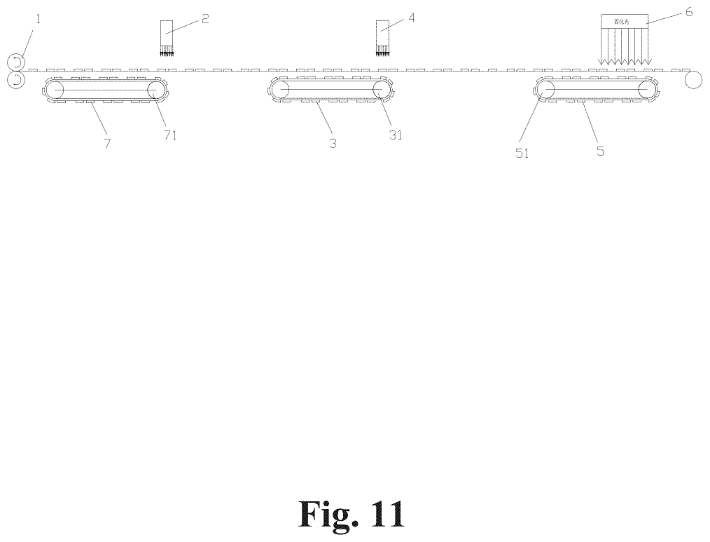

The embodiment provides another preparation device for a security pattern capable of writing variable coding information, it is similar to Embodiment I, and a difference is only that: as shown in FIG. 11, before a first group of point laser light source arrays 2, a group of synchronous magnetic fields 7 and a corresponding magnetic field conveying device 71 are arranged below a substrate 10, and are used to induce ink in a coated-printed pattern before the substrate 10 enters the first group of the point laser light source arrays 2.

### Embodiment VI

The embodiment provides another preparation method for a security pattern capable of writing variable coding information, including the following steps.

S1. A substrate with a coated-printed pattern is provided, and the coated-printed pattern is a cured state; ink paint used for coating-printing has a liquefaction effect on a light source, namely an exposed part of the coated-printed pattern may be turned from a high-molecule to a low-molecule, that is it is turned from a solid state to a liquid state; and at the same time, a pattern liquefied light source, a magnetic field and an end point curing mechanism are provided, the pattern liquefied light source may encode and control a lighting range and a lighting brightness of the light source, thereby generating a liquefied light source pattern. The magnetic field is arranged after the pattern liquefied light source, and the magnetic field is a magnetic field which is synchronously moved with the substrate or a fixed magnetic field.

S2. The coated-printed pattern on the substrate is conveyed to an irradiation range of the pattern liquefied light source, the liquefied light source pattern is transferred to the coated-printed pattern, so that an area, corresponding to the liquefied light source pattern, in the coated-printed pattern is turned to the liquid state.

S3. The substrate is continuously conveyed, in a conveying process, the coated-printed pattern on the substrate is induced by the magnetic field, so that a direction of the liquefied ink paint is re-induced.

S4. The substrate is continuously conveyed to an action range of the end point curing mechanism, so that the re-induced area is re-cured to form a new pattern.

During the preparation of the security pattern capable of writing the variable coding information according to the disclosure, along a direction in which the substrate is conveyed, the point light source arrays and the magnetic fields are arranged at intervals one by one, and a group of the magnetic field is arranged between every two adjacent groups of the point light sources, between the last group of the point light source array and the end point curing light source, and before the first group of the point light source array while the number of the magnetic fields is N+1 groups, as described in Embodiment V. Along the direction in which the substrate is conveyed, a head end of each magnetic field is overlapped or partially overlapped with the nearest point light source array or the end point curing light source, as shown in FIG. 10. A purpose of such design is that: the ink induced by the magnetic field may maintain the induced direction while it is cured, and confusion or blurring of the direction may not be caused due to demagnetization. Another scheme is that the magnetic field and the point light source array are not overlapped at all. In the conveying direction of the substrate, an end point of the magnetic field is abutted to an end point of the point light source array or even there is a certain distance, an advantage of such design is that: the magnetic field and the point light source array do not affect mutual effects on the ink in the coated-printed pattern.

1. (canceled)

2. A preparation device for a security pattern capable of writing variable coding information, wherein it comprises: a coating-printing mechanism, a substrate conveying mechanism, N groups of point light source arrays, N or N+1 groups of magnetic fields, and an end point curing light source, N=1; the N groups of the point light source arrays and the N or N+1 groups of the magnetic fields are arranged at the same side or two opposite sides of the substrate conveying direction;
the coating-printing device is used for coating and printing a pattern on the surface of a substrate;
the substrate conveying mechanism is used to convey the substrate coated-printed with the pattern; each point light source array is capable of controlling a lighting range and a lighting brightness according to real-time coding information, as to output an optical signal corresponding to the coding information to the pattern coated-printed on the substrate entering an irradiation range of the point light source array, and ink in a corresponding area on the coated-printed pattern is exposed and cured;
each magnetic field is used to induce the ink in an uncured part of the coating-painted pattern, as to change an angle thereof; and
the end point curing light source is arranged after the N groups of the point light source arrays and N or N+1 groups of the magnetic fields, and is used to cure all of the uncured part of the pattern, as to achieve complete exposure of the pattern.

3. The device as claimed in claim 2, wherein along a direction in which the substrate is conveyed, the point light source arrays and the magnetic fields are arranged at intervals one by one, and a group of the magnetic field is arranged between every two adjacent groups of the point light sources, between the last group of the point light source array and the end point curing light source, and before the first group of the point light source array while the number of the magnetic fields is N+1 groups.

4. The device as claimed in claim 3, wherein along the direction in which the substrate is conveyed, a head end of each magnetic field is overlapped or partially overlapped with the nearest point light source array.

5. The device as claimed in claim 2, wherein the magnetic field is a fixed magnetic field or a synchronous magnetic field synchronously conveyed with the substrate.

6. The device as claimed in claim 5, wherein the synchronous magnetic field is formed by fixing an induction magnet or an electromagnetic insert on a flexible conveying mesh belt, and aligned to the coated-printed pattern on the substrate.

7. The device as claimed in claim 5, wherein: the synchronous magnetic field adopts a mode of composite superposition of a plurality of the magnetic fields, magnetic force ranges of the magnetic fields are different according to sizes, positions and magnetic moments of the magnetic fields. According to the principle, the effect of a composite magnetic field is obtained by adding a short-distance small magnetic field to an existing long-distance.

8. The device as claimed in claim 2, wherein a minimum distance between the coated-printed pattern and the magnetic field is 0.1 MM-10 CM.

9. The device as claimed in claim 2, wherein the point light source array comprises a coding mechanism and an exposing mechanism, the coding mechanism is used to generate the coding information, and the exposing mechanism is used to control the lighting range and the lighting brightness of the point light source array according to the coding information; and the corresponding point light source is a single or multiple point light sources, and it is translated and/or switched on a two-dimensional plane, as to expose and cure a part corresponding to the pattern on the surface of the substrate.

10. The device as claimed in claim 9, wherein the point light source array is a point laser light source array.

11. The device as claimed in claim 10, wherein each laser tube in the point laser light source array is controlled by a circuit to switch and adjust energy intensity; and an equivalent diameter or a rectangular side length of a single point laser light source adopts a range of 10 ηM-10 MM.

12. The device as claimed in claim 11, wherein the point laser light source array is a two-dimensional array light source or a one-dimensional line array.

13. The device as claimed in claim 2, wherein the point light source array is a controllable point light source array, and condensation, collimation or projection of each controllable point light source thereof can be controlled by a circuit to switch; and an equivalent diameter or a rectangular side length of a single point light source adopts a range of 10 ηM-10 MM.

14. The device as claimed in claim 2, wherein the point light source array further comprises a controllable light barrier, it is arranged between the point light source array and the substrate. In the case that the light source of the point light source array is not changed, the exposure control of the point light source array can be achieved by controlling an opening degree of the controllable light barrier.

15. The device as claimed in claim 5, wherein:
the number of the point light source arrays is two, they are all arranged above the substrate, and the number of the synchronous magnetic fields is two, they are all arranged below the substrate;
the substrate conveying mechanism is used for conveying the substrate coated-printed with the pattern to an irradiation range of a first point light source array, and the first point light source array is used for outputting an optical signal corresponding to a first area shape and a light-dark pattern that need to be presented on the coated-printed pattern according to a coding signal, as to expose and cure the first area of the coated-printed pattern, and then the substrate is continuously conveyed by the substrate conveying mechanism, the first synchronous magnetic field is driven to be synchronously moved with the substrate by a first synchronous magnetic field conveying device, and the first synchronous magnetic field is used to induce the uncured part, namely the ink outside the first area, of the coating-painted pattern, as to change an angle thereof;
the substrate conveying mechanism is further used for conveying the substrate of which the first area is cured to an irradiation range of a second point light source array, and the second point light source array is used for outputting an optical signal corresponding to a second area shape and a light-dark pattern that need to be presented on the coated-printed according to the coding signal, as to expose and cure the second area of the coated-printed pattern after the action of the first synchronous magnetic field;
the substrate conveying device is further used for conveying the substrate after the action of the second point light source array to an irradiation range of the end point curing light source. In the process, the second synchronous magnetic field is driven to be synchronously moved with the substrate by a second synchronous magnetic field conveying device, the second synchronous magnetic field is used to induce the uncured part, namely ink of an area outside the first area and the second area, of the coated-printed pattern, as to change an angle thereof; and the end point curing light source is used to expose and cure the area after the action of the second synchronous magnetic field.

16. (canceled)

17. (canceled)
